(19) United States
(12) Patent Application Publication
(10) Pub. No.: US 2009/0204639 A1
(43) Pub. Date: Aug. 13, 2009

(54) SELECTIVE CONTENT REPLACEMENT FOR MEDIA PLAYERS

(75) Inventor: Travis M. Barrett, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/028,839

(22) Filed: Feb. 11, 2008

(51) Int. Cl. G06F 17/30; G06F 15/16

(52) U.S. Cl. 707/104.1; 709/204; 707/E17.001

(57) ABSTRACT

A network- and/or client-side media content replacement system/service (“MCRS”) facilitates identification and replacement of media content on media content players when defects associated with the media content players could negatively affect play of the media content. In one exemplary scenario, a media content player transmits a first message, which uniquely identifies the original media content item, to a network-based MCRS. It is determined based on the first message whether a defect associated with the media content player could negatively affect play of the original media content item, and if it is determined that play of the original media content item may be negatively affected, an alternate media content item is identified (for example, via a second message transmitted from the MCRS) to replace at least a portion of the original media content item.

### BACKGROUND

Media players are hardware, software, firmware, and combinations thereof that facilitate presentation of video, audio, image, multimedia, and application content (referred to collectively as “media content”) to users. Any type of device may be or may include a media player (such as a PCs or a portable audio/video player). As large amounts of relatively inexpensive data storage have become widely available, media player products have rapidly proliferated. Media content and media players, however—which are usually provided by different entities—can suffer from various defects that have the potential to disrupt a user's media content consumption experience.

### SUMMARY

Selective media content replacement techniques are described herein. One technique involves implementing a network- and/or client-side media content replacement system/service (“MCRS”), to identify and facilitate full or partial replacement of media content on a media content player when a defect associated with the media content player could negatively affect play of the media content.

In one exemplary scenario, upon acquisition of an original media content item or upon a user request to play an original media content item, the media content item is uniquely identified. For example, the media content player may transmit a message to a network-based MCRS uniquely identifying the original media content item and/or the media content player. It is determined based on the unique identity of the media content item and/or the media content player whether a defect associated with the media content player could negatively affect play of the original media content item.

There are many ways to determine whether there is a media player defect that could negatively affect play of the original media content item. In accordance with one exemplary manner, the determination is based on whether the type of media content player, the original media content item, and/or an alternate media content item corresponding to all or a portion of the original media content item appears in a particular collection of data, such as a database or a list, stored in a particular computer-accessible location. In accordance with another exemplary manner, the determination is made based on test results associated with particular items of media content and/or media content players.

If it is determined that play of the original media content item may be negatively affected, an alternate media content item is identified (for example, via a second message transmitted from the MCRS) to replace at least a portion of the original media content item on the media content player whose play could be negatively affected. The user of the media content player may optionally be queried to confirm whether the alternate media content item should be obtained and/or played. Alternate media content items and associated information (such as manifests of alternate media content items) may be located in various places, such as on the media content player, or at locations associated with networked servers or services, such as a location associated with a network-based MCRS.

This Summary is provided to introduce a selection of concepts in a simplified form. The concepts are further described in the Detailed Description section. Elements or steps other than those described in this Summary are possible, and no element or step is necessarily required. This Summary is not intended to identify key features or essential features of the claimed subject matter, nor is it intended for use as an aid in determining the scope of the claimed subject matter. The claimed subject matter is not limited to implementations that solve any or all disadvantages noted in any part of this disclosure.

### BRIEF DESCRIPTION OF THE DRAWINGS

FIG. 1 is a simplified block diagram of an exemplary communication architecture 100 via which media content is distributed and consumed.

FIG. 2 is a simplified functional block diagram of the media content replacement system/service (“MCRS”) shown in FIG. 1.

FIG. 3 is a flowchart illustrating certain aspects of a method performed using aspects of the communication architecture shown in FIG. 1 and/or the MCRS shown in FIG. 2.

FIG. 4 is a simplified block diagram of an exemplary operating environment in which aspects of the communication architecture shown in FIG. 1 and/or the method(s) shown in FIG. 2 may be implemented or used.

### DETAILED DESCRIPTION

A network- and/or client-side media content replacement system/service (“MCRS”), and techniques for operating the MCRS, are discussed herein. The MCRS facilitates the identification and replacement of media content on a media content player when one or more defects associated with the media content player could negatively affect play of the media content.

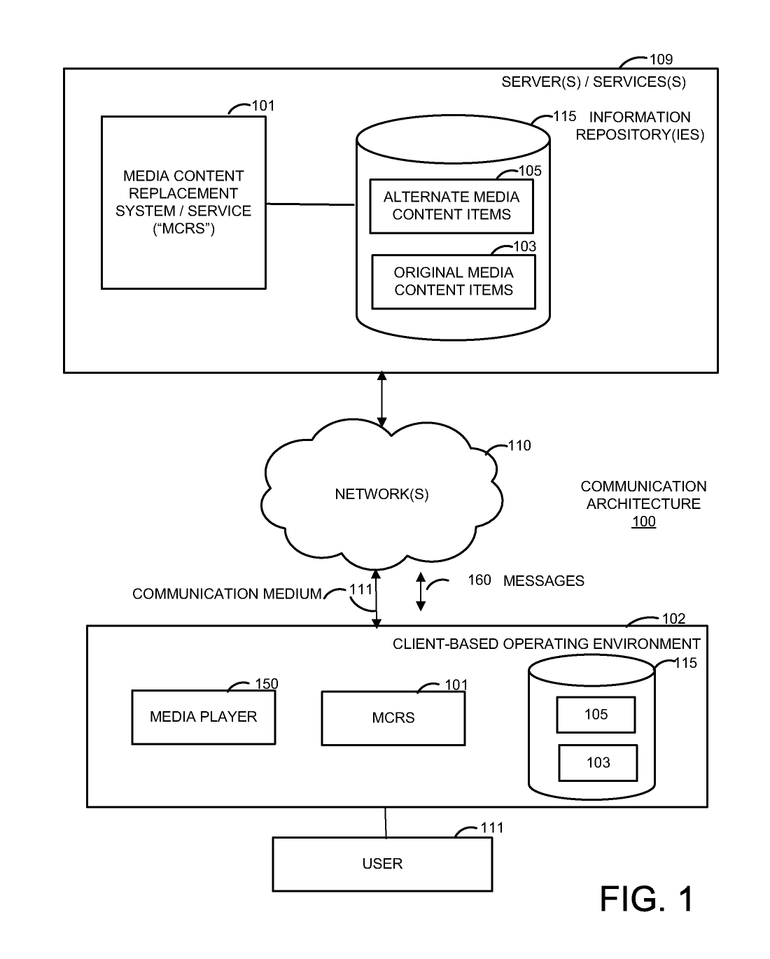

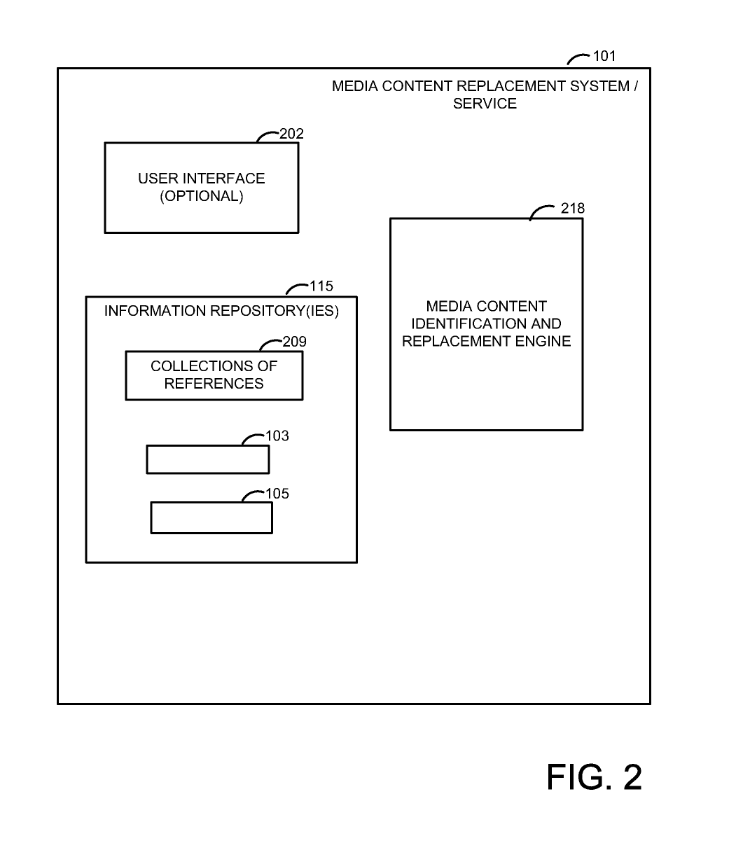

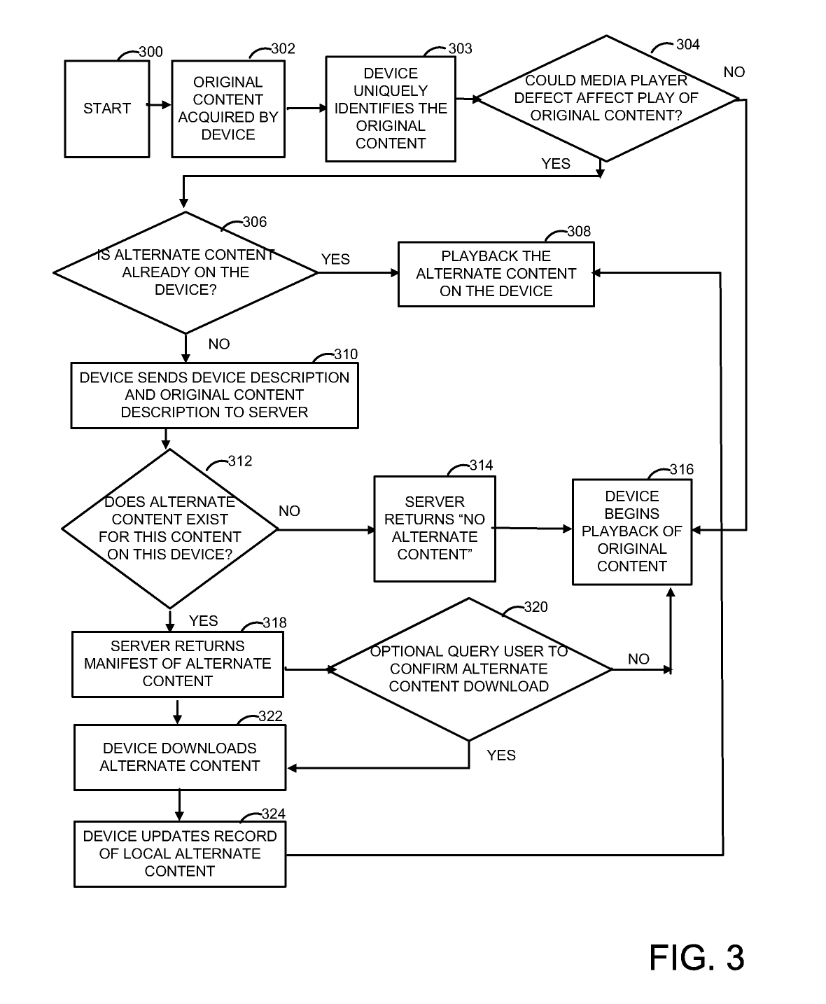

Turning to the drawings, where like numerals designate like components, FIG. 1 is a simplified block diagram of a communication architecture 100 via which media content (as shown, original media content items 103 and alternate media content items 105), which generally originates from one or more network-based servers/services 109, is distributed via network(s) 110/communication medium 115 to one or more client-based operating environments 102 (one shown) and operated by users 111 (one shown). As shown, client-based operating environment 102 includes a media player 150 and MCRS 101 (discussed further below, in connection with FIG. 2). MCRS 101 facilitates the identification (optionally via messages 160, discussed in connection with FIG. 3) of certain original media content items 103 or portions thereof whose play could be negatively affected because of defects in media player(s) 150, and replacement of identified original media content items 103 with alternate media content items 105.

Original media content items 103 and alternate media content items 105 (collectively, “media content items,” or “MCIs”) represent any commercial media content, including but not limited to media content such as audio files, video files, image files, multimedia files, playlists, metadata, applications, and the like. Exemplary types of MCIs include but are not limited to program content (for example, movies, television shows, music, and the like) and metadata associated therewith; and advertising content. Generally, MCIs are composed of a number of ordered content segments (for example, time-ordered or numerically-ordered content segments), which are playable by a particular media player as a content stream or executed as an application. It will be understood that a particular MCI may be, or may include, portions of what would be considered a larger work (such as a portion of a broadcast program). As such, a single MCI may be composed of multiple, separate groups of content segments; alternatively, individual groups of content segments may be treated as separate MCIs. Generally, each MCI (and also generally each content segment thereof) can be uniquely identified. One or more of the following items of information may be used to uniquely identify a particular MCI: distribution source identifiers; copyright holder identifiers; author/performer identifiers; stream identifiers; content sample identifiers; offset locations of content samples within streams; format information; and the like. MCIs may exist in any known or later developed format or combination of formats, and may be protected by one or more enforceable intellectual property rights of one or more entities, such as copyrights, patent rights, trademark rights, or trade secret rights. Alternate media content items 105 and their associated metadata may be encapsulated into a single file, and a new file format may be defined for such a file if desired.

Servers/services 109 represent any network-based sources of MCIs or services relating thereto, including but not limited to MCRS 101, data storage services, digital media content sources (for example, music or video downloading, broadcasting, or on-demand services, media production or distribution entities or services, or advertising production or distribution entities or services), peer devices or services, digital rights management servers or services (such as content packaging servers or services, licensing servers or services, and verification servers or services), and the like.

Collectively, networks 110 represent any existing or future, public or private, wired or wireless, wide-area or local-area, packet-switched or circuit-switched, one-way or two-way digital data transmission infrastructures or technologies. Exemplary networks 110 include: the Internet, managed wide-area networks (for example, cellular networks, satellite networks, fiber-optic networks, co-axial cable networks, hybrid networks, copper wire networks, and over-the-air broadcasting networks); and local area networks (for example, wireless or wired local area networks, and personal area networks.)

Client-based operating environment (“COE”) 102 represents any electronic device or hardware, software, firmware, or combination thereof (either standing alone or included in another device) operated by user 111, which is configured for communication via any network 110 within communication architecture 100 to obtain MCIs. User 111 is a person authorized to operate COE 102, who is generally a consumer of MCIs. COE 102 may be configured to render MCIs, or alternatively to pass MCIs to another device configured to render MCIs. When COE 102 is configured to render MCIs, media player 150 is generally part of COE 102, in the form of hardware, software, firmware, or any combination thereof. Examples of COEs 102 include but are not limited to PCs, mobile phones, personal digital assistants, personal media players, computer/television devices, set-top boxes, hard-drive storage devices, video cameras, DVD players, cable modems, gaming consoles, local media gateways, and devices temporarily or permanently mounted in transportation equipment such as wheeled vehicles, planes, or trains.

Any defects (hardware, firmware or software) present in a media player can prevent the correct playback and/or execution of media content. Examples of media player defects include but are not limited to audio and/or video decoder defects (for example, hardware or software CODECs); program interpreter defects (for example, script engine defects); and amplifier defects (for example, broken or inadequately-sized resistors or capacitors). Such defects may result in playback glitches, including but not limited to skipping of audio and/or video; audio artifacts such as buzzes or distortions; and video artifacts such as jagged lines, washed-out colors, or blurriness. Media player defects may also come in the form of technology incompatibility issues, which are noticeable, among other times, when media content is moved from one device to another (for example, from a television-based video recorder to a PC).

Although it may be possible to remedy media player defects via hardware, firmware, or software updates, such remediation often requires a substantial investment by providers of media players and providers of other types of COEs that include media players, and carries the risk of introducing new defects that may impact other media content. MCRS 101 addresses media player defects by facilitating the replacement of all or portions of original media content items 103 whose play could be negatively affected by such defects with alternate media content items 105 that compensate for media player defects. For example, audio and/or video encodings, or application instructions for presenting audio and/or video, may be modified to avoid specific media player defects. Any known or later developed modifications or ways for modifying media content may be employed to avoid media player defects. MCRS 101 and the media content replacement techniques discussed herein efficiently address the interests of media content providers, and media player providers, and while also meeting the needs of users for relatively glitch-free and user-friendly content acquisition and consumption.

With continuing reference to FIG. 1, FIG. 2 is a simplified functional block diagram of an exemplary implementation of a network- or client-side MCRS 101. MCRS 101 includes an optional user interface 202; information repository(ies) 115, which stores, among other things, original media content items 103, alternate media content items 105, and/or collections of references 209 to original media content items 103 and/or alternate media content items 105; and a media content identification and replacement engine (“MCIRE”) 218. In general, design choices dictate how specific functions of MCRS 101 are implemented. Such functions may be implemented using hardware, software, firmware, or combinations thereof.

User interface 202 represents the combination of presentation tools and controls that define the way a user interacts with a particular application or device, such as COE 102 or networked server(s)/service(s) 109 within network(s) 110. Presentation tools are used to provide output to a user. An example of a physical presentation tool is a display such as a monitor device. An example of a logical presentation tool is a data organization technique (for example, a window, a menu, or a layout thereof). Controls facilitate the receipt of input from a user. An example of a physical control is an input device such as a remote control, a display, a mouse, a pen, a stylus, a trackball, a keyboard, a microphone, or a scanning device. An example of a logical control is a data organization technique (for example, a window, a menu, or a layout thereof) via which a user may issue commands. It will be appreciated that the same physical device or logical construct may function to provide outputs to, and receive inputs from, a user.

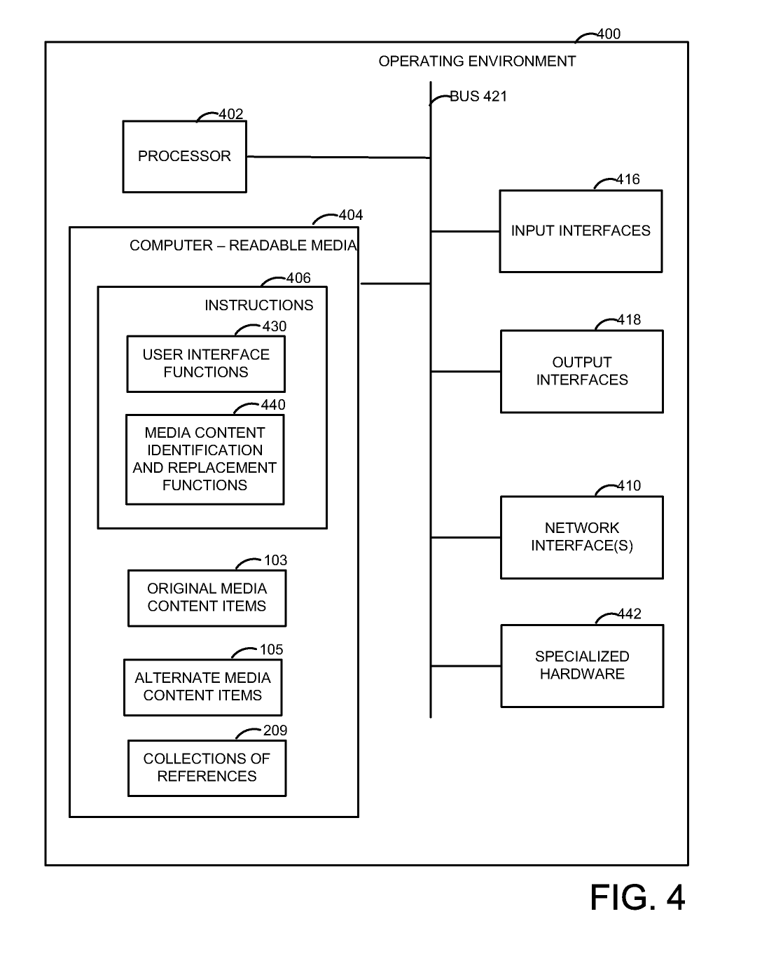

Information repository(ies) 115 represents data storage or organization capability. Information repository 115 may be implemented using various types and arrangements of computer-readable media (exemplary computer-readable media 404 are shown and described in connection with FIG. 4).

Collections of references 209 represent collections of data/information associated with particular original media content items 103 and/or alternate media content items 105. Collections of references 209 may be stored in one or more information repositories in the form of databases, lists, and the like. Exemplary information associated with particular original media content items and alternate media content items includes but is not limited to: metadata; URLs; and unique identifiers. The information about a particular original media content item or alternate media content item may serve as a medium for exchange of information about the media content item(s) between client-side and network-side MCRSs 101.

MCIRE 218 is configured to implemented functions of MCRS 101 relating to identification of original media content items 103 (or portions thereof) whose play may be negatively affected by media player defects, and replacement of such original media content items 103 or portions thereof with one or more alternate media content items 105. In one possible implementation, MCIRE 218 implements one or more features of a wide-area or local-area network service. In another possible implementation, MCIRE 218 implements one or more features of a client-based application.

With continuing reference to FIGS. 1 and 2, FIG. 3 is a flowchart of an exemplary method for playing media content by a media content player that may have one or more defects, using aspects of the MCRS illustrated in FIG. 2. It will be appreciated that the method of FIG. 3 is exemplary in nature, and that the subject matter defined in the claims is not necessarily limited to the specific features or acts described below. Rather, the specific features and acts described above are disclosed as example forms of implementing the claims.

The method shown in FIG. 3 may be implemented in one or more general, multi-purpose, or single-purpose processors, such as processor 402 discussed below in connection with FIG. 4. Aspects of the illustrated method may be performed by networked server(s)/service(s) 109 and/or COE 102 (via MCIRE 218, for example). For exemplary purposes, both COE-side acts and network-side acts are illustrated. Unless specifically stated, the methods described herein are not constrained to a particular order or sequence. In addition, some of the described method or elements thereof can occur or be performed concurrently.

The method begins at block 300, and continues at block 302, where an original media content item 103 is acquired by an electronic device, such as a personal media player device or another type electronic device that includes, or operates in conjunction with, a media player 150. Original media content item 103 may be acquired in any now known or later developed manner, such as via downloading, copying, streaming, broadcasting, datacasting, file transfer, or peer-to-peer content sharing.

At block 303, the electronic device (or a component thereof) uniquely identifies original media content item 103. Original media content items may be uniquely identified upon acquisition, or upon a user request to play a particular original media content item. Generally, an original media content item can be uniquely identified either via a predetermined universal identifier or a custom identification convention. In the former case, a multi-party agreed-upon identification scheme may be used, and a universal identifier may be associated with the original media content item prior to distribution of the item to the electronic device. In the case of the custom identification convention, for example, MCRS 101 may use one or more of the following items of information to create a unique identifier for a particular original media content item 103: a checksum; metadata; distribution source identifiers; copyright holder identifiers; author/performer identifiers; stream identifiers; content sample identifiers; offset locations of content samples within streams; format information; and the like. The information used to uniquely identify original media content item 103 is optionally part of a schema, such as an XML schema, that is used to encapsulate data being passed between a client-side MCRS 101 and a network-side MCRS 101.

Next, at diamond 304, it is ascertained whether a media player defect could affect play of the original media content item or a portion thereof. It will be appreciated that there are many ways to make the determination of whether a media player defect could negatively affect play of the original media content item. In accordance with one exemplary manner, the determination is based on whether the type of media content player (or the specific media content player), the original media content item, and/or an alternate media content item corresponding to all or a portion of the original media content item appears in a particular collection of references 209, such as a database or a list, stored in an information repository 115 at a client-side device or operating environment or at a network-based server or service. In accordance with another exemplary manner, the determination is made based on test results associated with particular items of media content and/or media content players.

In the exemplary scenario illustrated in FIG. 3, a client-side MCRS 101 may attempt to locate one or more alternate media content items 105 whose existence implies that there is a defect associated with the media content player that could affect play of the original media content item. Client-side MCRS 101 may act independently, or in conjunction with one or more MCRSs 101 within network(s) 110 to locate alternate media content items 105.

As illustrated at diamond 306 of FIG. 3, it may be initially ascertained whether there is alternate media content to replace the original media content item already on the electronic device. For example, client-side MCRS 101 may compare the unique identifier of the original media content item to identifiers within a particular collection of references 209, such as a database or a list of alternate media content items on the device. When it is determined that the unique identifier corresponds to a reference within the particular collection (that is, there is alternate media content already on the electronic device), then the original media content item (or a portion thereof) may be automatically replaced with the appropriate alternate media content item(s) prior to playback by the media player, as indicated at block 308.

When there is not alternate media content on the electronic device, client-side MCRS 101 may act in conjunction with one or more MCRSs 101 within network(s) 110 to ascertain the existence of alternate media content items 105. Communications between client-side MCRSs 101 and server-side MCRSs 101 could occur over any now known or later-developed communication medium 111 and/or transport protocol. A custom protocol may optionally be used to create and/or populate messages 160, which are used to convey information between client-side MCRSs and server-side MCRSs.

As indicated at block 310, a first message 160 would generally be used to transmit information to server-side MCRS 101 regarding the electronic device, the original media content item(s), and/or the media content player responsible for rendering the original media content item.

Based on the first message, at diamond 312, server-side MCRS 101 ascertains whether there is or is not alternate content to replace the original media content item on the particular electronic device (that is, whether any alternate media content exists for the particular device-content pairing). In one exemplary scenario, the server-side MCRS compares the unique identifier of the original media content item to identifiers within a particular collection of references 209 on one or more servers or services 109, such as a database or a list of alternate media content items available for a particular media player or type thereof, to locate alternate media content. Server-side MCRS 101 would generally use a second message 160 to transmit information regarding alternate media content to the client-side MCRS/electronic device. As indicated at block 314, when no alternate media content items 105 are found, then the second message would indicate “no alternate content”, and the electronic device could commence playback of the original content item. When one or more alternate media content items 105 are found, then the second message may be used to return information regarding the alternate media content items (such as the alternate media content items 105 or referenced thereto, such as manifests), as indicated at block 318.

Optionally, as indicated at diamond 320, the user may be queried to confirm whether he or she desires to replace the original media content item with one or more alternate media content items 105. The electronic device may automatically download the alternate media content item(s) 105 and inform/query the user, or may inform/query the user prior to downloading alternate media content.

Assuming that the second message did not include the alternate media content item(s) 105 and the user desires to replace the original media content item, then, as indicated at block 322, the electronic device downloads the alternate media content item(s). The collection of references 209 specifying locally-stored alternate media content may be updated, as indicated at block 324. Any attempt to playback/execute the original content item then results in the playback/execution of the alternate content item(s), as indicated at block 308.

Thus, alternate media content items 105 may be used to ensure correct playback and/or execution of media content, even when media player defects would cause playback glitches within the corresponding original media content items. The cost of creating and distributing alternate media content items 105 (which may be a fraction of the size of the original media content items, if only a portion of the original media content items are affected) is generally less than the cost of recalling or updating media player products. Accordingly, the selective media content replacement techniques discussed herein efficiently address the interests of media content providers, and media player providers, while also meeting the needs of users for relatively glitch-free, user-friendly content acquisition and consumption.

With continuing reference to FIGS. 1 through 3, FIG. 4 is FIG. 4 is a simplified block diagram of an exemplary operating environment 400 in which aspects of the communication architecture shown in FIG. 1, the MCRS shown in FIG. 2, and/or the method(s) shown in FIG. 3 may be implemented or used. Operating environment 400 is generally indicative of a wide variety of general-purpose or special-purpose computing environments, and is not intended to suggest any limitation as to the scope of use or functionality of the system(s) and methods described herein. For example, operating environment 400 may be a consumer electronic device such as a mobile phone, a personal digital assistant, a personal computer, a personal media player, a computer/television device, a set-top box, a hard-drive storage device, a video camera, a DVD player, a cable modem, a local media gateway, a device temporarily or permanently mounted in transportation equipment such as a wheeled vehicle, a plane, or a train, or another type of known or later developed consumer electronic device. Operating environment 400 may also be a type of networked server, or any aspect thereof. Such a server may be part of a distributed computing network, and may be used to implement, host, or proxy any type of network-based service in whole or in part.

As shown, operating environment 400 includes processor 402, computer-readable media 404, and computer-executable instructions 406. One or more internal buses 421 may be used to carry data, addresses, control signals, and other information within, to, or from operating environment 400 or elements thereof.

Processor 402, which may be a real or a virtual processor, controls functions of the operating environment by executing computer-executable instructions 406. The processor may execute instructions at the assembly, compiled, or machine-level to perform a particular process.

Computer-readable media 404 may represent any number and combination of local or remote devices, in any form, now known or later developed, capable of recording, storing, or transmitting computer-readable data, such as the above-noted computer-executable instructions 406 (user interface functions 430 and media content identification and replacement functions 440 are shown), collections of references 209, original media content items 103, or alternate media content items 105. In particular, computer-readable media 404 may be, or may include, a semiconductor memory (such as a read only memory (“ROM”), any type of programmable ROM (“PROM”), a random access memory (“RAM”), or a flash memory, for example); a magnetic storage device (such as a floppy disk drive, a hard disk drive, a magnetic drum, a magnetic tape, or a magneto-optical disk); an optical storage device (such as any type of compact disk or digital versatile disk); a bubble memory; a cache memory; a core memory; a holographic memory; a memory stick; a paper tape; a punch card; or any combination thereof. The computer-readable media may also include transmission media and data associated therewith. Examples of transmission media/data include, but are not limited to, data embodied in any form of wireline or wireless transmission, such as packetized or non-packetized data carried by a modulated carrier signal.

Computer-executable instructions 406 represent any signal processing methods or stored instructions. Generally, computer-executable instructions 406 are implemented as software components according to well-known practices for component-based software development, and encoded in computer-readable media. Computer programs may be combined or distributed in various ways. Computer-executable instructions 406, however, are not limited to implementation by any specific embodiments of computer programs, and in other instances may be implemented by, or executed in, hardware, software, firmware, or any combination thereof.

Input interface(s) 416 are any now known or later developed physical or logical elements that facilitate receipt of input to operating environment 400.

Output interface(s) 418 are any now known or later developed physical or logical elements that facilitate provisioning of output from operating environment 400.

Network interface(s) 410 represent one or more physical or logical elements, such as connectivity devices or computer-executable instructions, which enable communication between operating environment 400 and external devices or services, via one or more protocols or techniques. Such communication may be, but is not necessarily, client-server type communication or peer-to-peer communication. Information received at a given network interface may traverse one or more layers of a communication protocol stack.

Specialized hardware 442 represents any hardware or firmware that implements functions of operating environment 400. Examples of specialized hardware include encoder/decoders decrypters, application-specific integrated circuits, clocks, and the like.

It will be appreciated that particular configurations of operating environment 400 may include fewer, more, or different components or functions than those described. In addition, functional components of operating environment 400 may be implemented by one or more devices, which are co-located or remotely located, in a variety of ways.

Functions/components described herein as being computer programs are not limited to implementation by any specific embodiments of computer programs. Rather, such functions/components are processes that convey or transform data, and may generally be implemented by, or executed in, hardware, software, firmware, or any combination thereof.

It will be understood that when one element is indicated as being responsive to another element, the elements may be directly or indirectly coupled. Connections depicted herein may be logical or physical in practice to achieve a coupling or communicative interface between elements. Connections may be implemented, among other ways, as inter-process communications among software processes, or inter-machine communications among networked computers.

The word “exemplary” is used herein to mean serving as an example, instance, or illustration. Any implementation or aspect thereof described herein as “exemplary” is not necessarily to be constructed as preferred or advantageous over other implementations or aspects thereof.

As it is understood that embodiments other than the specific embodiments described above may be devised without departing from the spirit and scope of the appended claims, it is intended that the scope of the subject matter herein will be governed by the following claims.

What is claimed is:

1. A method for playing media content using a media content player, the method comprising:
acquiring an original media content item playable by the media content player;
ascertaining whether a defect associated with the media content player could negatively affect play of the original media content item;
when it is ascertained that a defect associated with the media content player could negatively affect play of the original media content item, identifying an alternate media content item to replace at least a portion of the original media content item whose play could be negatively affected; and
prior to playing the portion of the original media content item whose play could be negatively affected, replacing the portion of the original media content item with the alternate media content item.

2. The method according to claim 1, wherein the step of ascertaining whether a defect associated with the media content player could negatively affect play of the original media content item comprises:
uniquely identifying either the original content item or the portion of the original content item or both;
identifying a collection of references to alternate media content items, each reference in the collection corresponding to a particular original content item or a predetermined portion of a particular original content item; and
determining whether the uniquely identified original content item or the portion of the original content item or both corresponds to one or more references to alternate media content items in the collection,
a determination that the uniquely identified original content item or the portion of the original content item or both corresponds to one or more references to alternate media content items in the collection impliedly indicating that there is a defect with the media content player that could negatively affect play of the original media content item by the media content player.

3. The method according to claim 2, wherein the step of identifying an alternate media content item comprises identifying the one or more references to alternate media content items in the collection that correspond to the uniquely identified original content item or the portion of the original media content item or both.

4. The method according to claim 2, wherein the collection is located either locally or remotely with respect to the media content player.

5. The method according to claim 1, wherein the step of ascertaining whether a defect associated with the media content player could negatively affect play of the original media content item comprises:
transmitting a first message to a network-based service via a communication medium, the first message identifying the media content player and uniquely identifying the original media content item or the portion of the original media content item or both;
based on the first message, receiving a second message from the network-based service via the communication medium, the second message indicating whether a defect associated with the media content player could negatively affect play of the original media content item by the media content player.

6. The method according to claim 5, wherein the second message further indicates the portion of the original media content item whose play could be negatively affected.

7. The method according to claim 5, wherein a location of the network-based service is selected from the group comprising: a wide-area communication network and a local-area communication network, and wherein the communication medium is selected from the group comprising: a wireless communication channel; and a wired communication channel.

8. The method according to claim 7, wherein the wide-area communication network is selected from the group comprising: the Internet; a broadcast network; a telecommunication network; a datacasting network; a cable network; and a satellite network, and wherein the local-area communication network is selected from the group comprising: a WiFi network; an in-home home network; a personal area communication network; and a Bluetooth network.

9. The method according to claim 5, wherein the step of identifying an alternate media content item comprises
based on the second message, locating an alternate media content item in a computer-readable storage medium.

10. The method according to claim 9, wherein the second message includes a reference to the alternate media content item, and wherein the computer-readable storage medium is selected from the group comprising: a local computer-readable storage medium and a remote computer-readable storage medium.

11. The method according to claim 10, wherein the reference to the alternate media content item comprises a manifest of the alternate media content item.

12. The method according to claim 10, wherein the remote computer-readable storage medium is selected from the group comprising: the network-based service; a file transmitted via the second message; a computer-readable storage medium separate from the network-based service within a wide-area communication network; and a computer-readable storage medium separate from the network-based service within a local-area communication network.

13. The method according to claim 1, wherein either the original media content item or the alternate media content item or both are selected from the group comprising: images; video content; audio content; multimedia content; and instructions for playing images, video content, audio content, or multimedia content.

14. The method according to claim 1, further comprising:
when an alternate media content item is identified, prior to replacing the portion of the original media content item with the alternate media content item, obtaining user input to determine whether to replace the original media content item with the alternate media content item.

15. A method for selectively replacing media content playable by a media content player, the media content player configured for communication via a communication medium, the method comprising:
receiving a first message via the communication medium, the first message identifying the media content player and uniquely identifying an original media content item;
based on the first message, determining whether a defect associated with the media content player could negatively affect play of the original media content item;
when it is determined that a defect associated with the media content player could negatively affect play of the original media content, identifying an alternate media content item to replace at least a portion of the original media content item whose play could be negatively affected; and
transmitting a second message via the communication medium, the second message identifying the alternate media content item,
the second message usable by the media content player to replace the portion of the original media content item whose play could be negatively affected with the alternate media content item.

16. The method according to claim 15, wherein contents of second message are selected from the group comprising: a manifest associated with the alternate media content item; a file including the alternate media content item; and a reference to a location from which the media content player can obtain the alternate media content item.

17. The method according to claim 15, wherein the first and second messages comprise information represented using an XML schema.

18. An apparatus, comprising:
a computer-readable storage medium; and
a processor responsive to the computer-readable storage medium and to a computer program, the computer program, when loaded into the processor, operable to
in response to a user requesting play of an original media content item by a media content player, ascertain whether the media content player has a defect that could negatively affect play of the original media content item;
when it is ascertained that the media content player has a defect that could negatively affect play of the original media content item, arrange for identification of an alternate media content item to replace at least a portion of the original media content item whose play could be negatively affected; and
prior to play by the media content player of the portion of the original media content item whose play could be negatively affected, facilitate replacement of the portion of the original media content item with the alternate media content item.

19. The apparatus according to claim 18, wherein the computer-readable medium is located within an electronic device, operable by the user, within which the media content player is implemented.

20. The apparatus according to claim 18, wherein the computer-readable medium is located within a server configured for communication with an electronic device, operable by the user, within which the media content player is implemented.
